(19) United States
(12) Patent Application Publication
(10) Pub. No.: US 2016/0050007 A1
(43) Pub. Date: Feb. 18, 2016

(54) TRANSMISSION APPARATUS AND METHOD OF MASSIVE MULTI-ANTENNA SYSTEM

(71) Applicants: SAMSUNG ELECTRONICS CO., LTD., Gyeonggi-do (KR); INDUSTRY-ACADEMIC COOPERATION FOUNDATION, YONSEI UNIVERSITY, Seoul (KR)

(72) Inventors: Hyojin LEE, Gyeonggi-do (KR); Chungyong LEE, Seoul (KR); IIkyu CHOI, Seoul (KR); Younsun KIM, Gyeonggi-do (KR); Juho LEE, Gyeonggi-do (KR); Hyoungju JI, Seoul (KR); Hoondong NOH, Gyeonggi-do (KR); Sangwon PARK, Seoul (KR)

(21) Appl. No.: 14/782,551

(22) PCT Filed: Apr. 7, 2014
(86) PCT No.: PCT/KR2014/002988

§ 371 Date: Oct. 5, 2015

(30) Foreign Application Priority Data
Apr. 5, 2013 (KR) 10-2013-0037571

(51) Int. Cl. H04B 7/06; H04L 5/14; H04L 25/02; H04B 7/04; H04B 17/10

(52) U.S. Cl. CPC H04B 7/0639; H04B 7/0413; H04B 17/104; H04L 25/0202; H04L 5/14

(57) ABSTRACT

The present invention relates to a method and apparatus for supporting multi-users using a massive MIMO technology in an FDD environment. A communication method of a UE in a MIMO system according to an embodiment of the present invention may comprise: estimating a channel; calculating a first precoding matrix indication having a minimum correlation with the estimated channel; and transmitting the calculated first precoding matrix indication to a BS. According to an embodiment of the present invention, in a massive MIMO system, the UE feeds not a pre-coder close to a channel thereof but a pre-coder close to a null space of a channel back to the BS, so that an IUI can be reduced even in an

### TECHNICAL FIELD

The present invention relates to a method of feeding a Precoding Matrix Indication (PMI) for reducing an Inter-User Interference (IUI) back to a Base Station (BS), by a User Equipment (UE), when supporting multi-users using a massive Multi-Input Multi-Output (MIMO) technology in a Frequency-Division Duplex (FDD) environment.

### BACKGROUND ART

The massive MIMO system can satisfy a high data rate required in the next generation communication system only using a simple linear pre-coder by installing a plurality of antennas in a BS. Theoretically, when the infinite number of antennas are used, various problems limiting a system performance, such as an IUI as well as fast fading, can be perfectly removed. Since such an advantage of the Massive MIMO system can be achieved when the BS knows accurate channel information, research for the existing massive MIMO is performed on a Time-Division Duplex system in which a massive MIMO channel can be estimated with low costs due to channel reciprocity.

However, in the TDD system, when a distance between transmission/reception terminals is large or when a data transmission amount from an UpLink (UL) to a DownLink (DL) and a data transmission amount from the DL to the UL are similar to each other, a frequency efficiency may deteriorate due to transmission-reception mode conversion as compared with the FDD system. For the above reason, in the plurality of existing communication systems such as UMTS, WCDMA, CDMA2000, etc., an FDD mode is supported. Therefore, in order to ensure backward compatibility, it is necessary to implement the massive MIMO technology in an FDD environment.

Since a massive MIMO channel has a high quantization error in a limited feedback environment, the IUI cannot effectively be reduced when only a precoder closest to a channel of the UE is fed back and used as in the related art. The present invention has been proposed to improve such a phenomenon.

### DETAILED DESCRIPTION OF THE INVENTION

### Technical Problem

An aspect of the present invention is to solve a phenomenon in which it is difficult to reduce an IUI due to a high quantization error when a BS receives a feedback of the conventional PMI from a UE and pre-codes the conventional PMI in an FDD massive MIMO environment. A method is proposed in which the UE feeds not a pre-coder close to a channel thereof but a pre-coder close to a null space of a channel back to a BS, and thus, an IUI is reduced even in the FDD massive MIMO environment.

The technical subjects pursued in the present invention may not be limited to the above mentioned technical subjects, and other technical subjects which are not mentioned may be clearly understood, through the following descriptions, by those skilled in the art of the present invention

### Solution to Problem

In order to achieve the aspect, a communication method of a UE in a MIMO system according to an embodiment of the present invention may include: estimating a channel; calculating a first precoding matrix indication with a minimum correlation with the estimated channel; and transmitting the calculated first precoding matrix indication to a BS.

Further, the transmitting of the calculated first precoding matrix indication to the BS may include: calculating an SNR of the UE; determining whether the calculated SNR is larger than a predetermined threshold value; and when the calculated SNR is larger than the predetermined threshold value, transmitting the calculated first precoding matrix indication to the BS.

Further, the communication method may further include: calculating a second precoding matrix indication having a maximum correlation with the estimated channel; and when the calculated SNR is smaller than the predetermined threshold value, transmitting a second precoding matrix indication having the maximum correlation with the channel of the UE itself, to the BS.

Further, in the transmitting of the calculated first precoding matrix indication to the BS, an indicator indicating whether the first precoding matrix indication is transmitted is included.

Further, the transmitting of the calculated first precoding matrix indication to the BS may include: calculating a second precoding matrix indication having a maximum correlation with the estimated channel; transmitting the first precoding matrix indication to the BS in a predetermined first period; and transmitting the second precoding matrix indication to the BS in a predetermined second period.

A communication method of a BS in a MIMO system according to an embodiment of the present invention may include: receiving, from a first UE, a first precoding matrix indication having a minimum correlation with a channel of the first UE itself; and determining a precoding matrix indication to be used for communication of a second UE, using the first precoding matrix indication.

Further, the receiving of the first precoding matrix indication may further include: receiving an indicator indicating whether the precoding matrix indication received from the first UE is the first precoding matrix indication having the minimum correlation with the channel of the first UE; and determining whether the precoding matrix indication received through the indicator is the first precoding matrix indication.

Further, a UE of a MIMO system according to an embodiment of the present invention may include: a communication unit that communicates with a BS; and a controller that makes a control to calculate a first precoding matrix indication having a minimum correlation with the estimated channel, and transmit the calculated first precoding matrix indication to the BS.

A BS of a MIMO system according to an embodiment of the present invention may include: a communication unit that communicates with a UE; and a controller that makes a control to receive, from a first UE, a first precoding matrix indication having a minimum correlation with a channel of the first UE itself, and determine a precoding matrix indication to be used for communication of a second UE, using the first precoding matrix indication.

### Advantageous Effects of Invention

In a massive MIMO system according to an embodiment of the present invention, a UE feeds not a pre-coder close to a channel thereof but a pre-coder close to a null space of a channel back to a BS, so that an IUI can be reduced even in an FDD massive MIMO environment.

Effects obtainable from the present invention may not be limited to the above mentioned effects, and other effects which are not mentioned may be clearly understood, through the following descriptions, by those skilled in the art of the present invention.

### BRIEF DESCRIPTION OF THE DRAWINGS

FIG. 1 is a view illustrating feedbacks of a PMI and a CQI of a UE;

FIGS. 2 and 3 are views illustrating correlation probability density functions between a standard channel and a codebook;

FIG. 4 is a view illustrating a feedback bit structure according to the size of a reception SNR according to an embodiment of the present invention;

FIG. 5 is a view illustrating a PMI/NPMI feedback area according to an embodiment of the present invention;

FIG. 6 is a flowchart illustrating a method of selecting two NPMI UEs according to an embodiment of the present invention;

FIG. 7 is a view illustrating a switching process between PMI/NPMI according to an embodiment of the present invention; and

FIG. 8 is a flowchart illustrating a method of selecting a partner UE according to an embodiment of the present invention.

### MODE FOR THE INVENTION

In describing the present disclosure below, a detailed description of related known configurations or functions incorporated herein will be omitted when it is determined that the detailed description thereof may unnecessarily obscure the subject matter of the present disclosure. Hereinafter, embodiments of the present disclosure will be described with reference to the accompanying drawings. The terms which will be described below are terms defined in consideration of the functions in the present disclosure, and may be different according to users, intentions of the users, or customs. Accordingly, the terms should be defined based on the contents over the whole present specification.

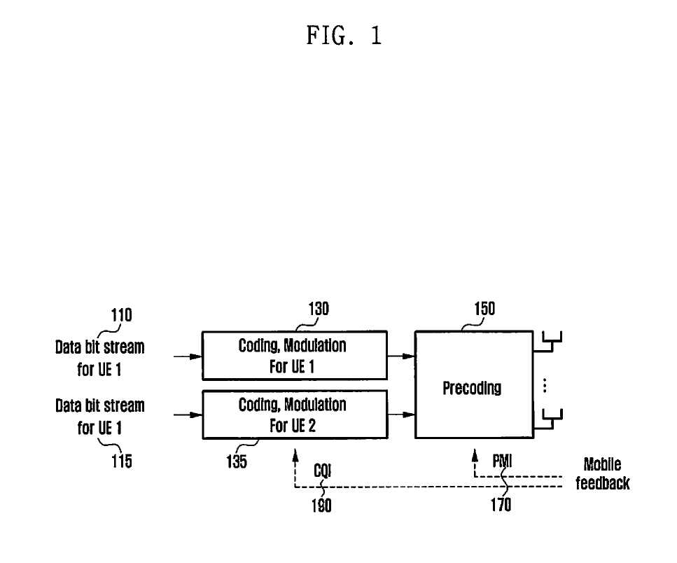

FIG. 1 is a view illustrating feedbacks of a PMI and a CQI of a UE.

A distance between two normalized vectors a and b can be measured by a chordal distance d=\sqrt{1−|a^{H}b|²}, and the fact that the distance is short implies that a correlation c=|a^{H}b|² is high. The correlation has a value from 0 to 1, and when the correlation is 0, the two vectors are completely orthogonal to each other, and when the correlation is 1, the two vectors completely coincide with each other.

When it is assumed that the number of transmission antennas of the BS is M and a reception antenna of each UE is 1, a DL channel and a pre-coder of a UE k are expressed as a vector k and a vector w_{ig} having the size of M×1, respectively. The UE k searches a codebook W={w₁, . . . , w_{N}} having the size of N for the pre-coder wₚₖ closest to the channel hₖ thereof, and designates an indicator pₖ of the discovered pre-coder wₚₖ as a Precoding Matrix Indication (PMI) thereof. The process may be expressed as Equation (1).

$${p}_{k} = {argmax}_{p ∈ \{ 1 , 2 , … , N \}} {\vert {h}_{k}^{H} {w}_{p} \vert}^{2} \qquad ( 1 )$$

Thereafter, a Channel Quality Indication (CQI) can be calculated by Equation (2).

CQIₖ=ρ|hₖ^{H}wₚₖ|² (2)

Here, ρ implies a Signal-to-Noise Ratio (SNR) of the DL.

Referring to FIG. 1, the calculated CQI 190 and the calculated PMI 170 can be fed back to a BS. The fed-back CQI 190 is used to determine a code rate 130 and a modulation order 135 and the PMI 170 is used for precoding 150.

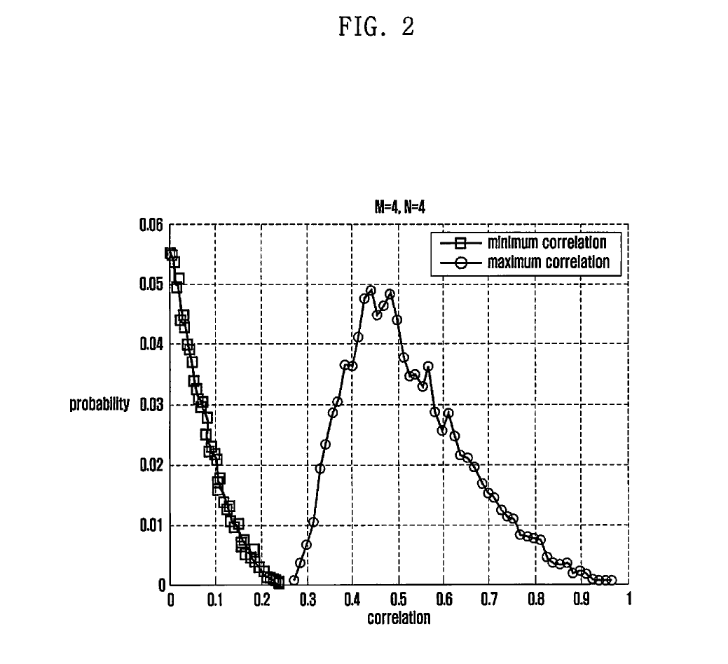

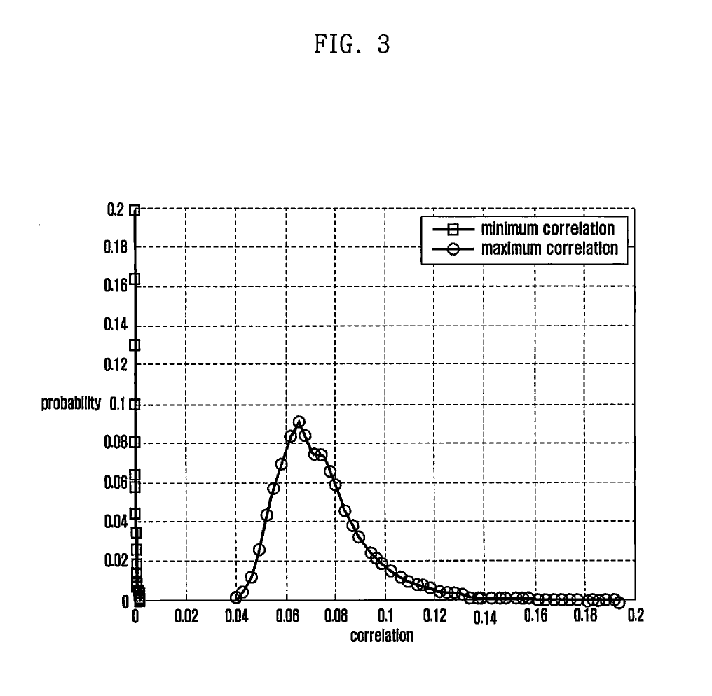

FIGS. 2 and 3 are views illustrating correlation probability density functions between a standard channel and a codebook.

FIGS. 2 and 3 illustrate Probability Density Functions (PDFs) with regard to a maximum value and a minimum value among a correlation between a normalized channel \tilde{h}=h/||h|| and a codebook. FIG. 2 illustrates a PDF when the number M of antennas is 4, and FIG. 3 illustrates a PDF when the number M of antennas is 64. A Discrete Fourier Transform (DFT) which is optimal on the basis of the Grassmannian criterion when the number M of antennas and the size N of a codebook are equal to each other may be used as the codebook. The PDF with regard to the maximum correlation indicates how accurately the UE can feed a channel thereof back to the BS when the UE searches the codebook having the size of N for a pre-coder closest to the channel thereof and feeds an indicator of the discovered pre-coder back to the BS. As an average of the PDF is closer to 1, the pre-coder more accurately coincides with a channel, and as the average of the PDF is closer to 0, the pre-coder is orthogonal to a channel close to a null space of a channel.

As illustrated in the maximum correlation of FIG. 2, in the existing MIMO system in which M is 4, even when a UE searches for a pre-coder closest to a channel thereof and feeds the discovered channel back to a BS through a PMI, a value of the entire correlation is relatively high. However, as illustrated in the maximum correlation of FIG. 3, in the massive MIMO system in which M=64, when a PMI is fed back to the BS, the value of the entire correlation is very low due to a quantization error. The reason is that the size N of the codebook is increased exponentially to the number M of antennas in order to obtain a predetermined quantization error. For the reaction, in a limited feedback environment, when the conventional PMI is fed back to the BS, it is difficult for the UE to accurately notify the UE of a massive MIMO channel. Since it is difficult to remove an IUI using an inaccurate channel, it is difficult to support multi-users.

In this case, the UE can feed a channel thereof and an indicator of a pre-coder having the lowest correlation back to the BS. In the specification of the present invention, the channel of the UE itself and the indicator of the pre-coder having the lowest correlation are used as a Negative PMI (NPMI). The NPMI is a concept opposite to the existing PMI, and an NPMI of the UE k can be calculated by Equation (3).

$${n}_{k} = {argmax}_{n ∈ \{ 1 , 2 , … , N \}} {\vert {h}_{k}^{H} {w}_{n} \vert}^{2} \qquad ( 3 )$$

The NPMI is fed back to the BS, and may be used as a PMI of not the UE k, which has performed the feedback, but one other UE j, which causes the IUI to the UE k. That is, the UE k can notify the BS of a pre-coder wₙₖ which causes the smallest IUI to the UE k itself, and the one other UE j can use the pre-coder.

As illustrated in FIGS. 2 and 3, an average of the PDF of the minimum correlation is closer to 0 as the number M of antennas becomes larger. This fact implies that it is difficult to accurately perform a feedback of the channel itself in a massive MIMO environment but a null space thereof can be accurately fed back. The NPMI corresponds to information on a PMI on which characteristics of the massive MIMO channel are reflected, and can enable the precoding which reduces the IUI in a FDD massive MIMO environment. The CQI is calculated by Equation (2) as in the related art. However, in this case, the CQI may be used as not a reception performance of the UE itself but a barometer of the IUI.

According to an embodiment, the UE can feed the NPMI or the PMI back to the BS according to a reception SNR. For example, when a situation is assumed in which the two UEs k and j receive support, a Signal-to-Interference-plus-Noise Ratio (SINR) of the UE k can be calculated by Equation (4).

$${SINR}_{k} = \frac{{\vert {\overline{h}}_{k}^{H} {w}_{pk} \vert}^{2}}{{\vert {\overline{h}}_{k}^{H} {w}_{pj} \vert}^{2} + 2 / ( ρ {‖ {h}_{k} ‖}^{2} )} \qquad ( 4 )$$

When the SNR (ρ||hₖ||²/2) is low, a reciprocal number (2/ρ||hₖ||²) of the SNR, which exists in a denominator of the SINR, is relatively higher than the IUI (|\tilde{h}ₖ^{H}wₚⱼ|²). Thus, the conventional technology of performing a feedback of a PMI, which maximizes a numerator, may be advantageous. However, when the reception SNR is high, the TUT is relatively high. Therefore, it may be difficult to support multi-users without an IUI reduction technique.

At this time, when the UE k performs support using the NPMI of the UE j, and the UE j performs support using the NPMI of the UE k, the IUI is reduced, and thus, it is possible to smoothly support the multi-users. That is, pₖ=nⱼ and pⱼ=nₖ are satisfied.

According to an embodiment, each UE can perform a feedback of the NPMI according to a predetermined threshold of the SNR. For example, each UE calculates the reception SNR. When the calculated SNR value is larger than the threshold value, it is determined that the IUI reduction is important, and thus, each UE performs feedback of the NPMI, and otherwise, each UE can perform feedback of the conventional PMI. Here, although an average value has been previously stored in the UE as the threshold value, the threshold value may be designated by the BS sometimes as p is changed. In this case, the threshold value can be transmitted in a communication scheme such as an RRC, a PDCCH, etc.

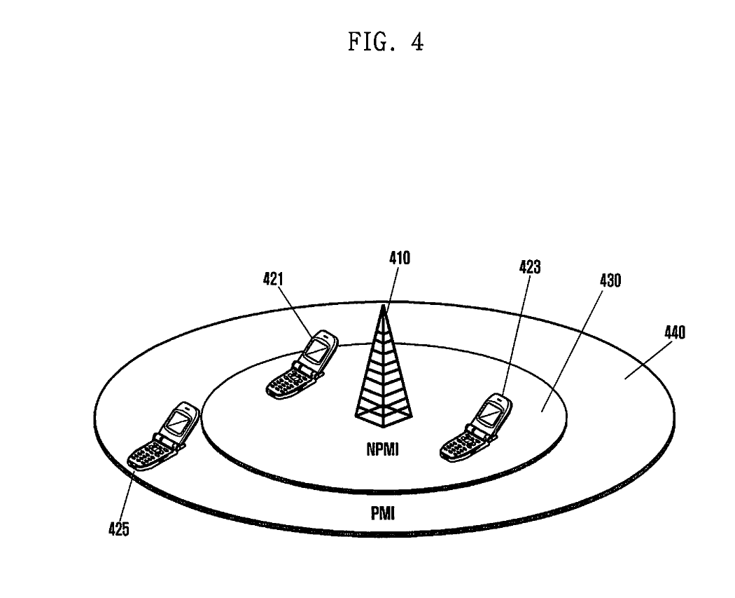

FIG. 4 is a view illustrating a feedback bit structure according to the size of a reception SNR according to an embodiment of the present invention.

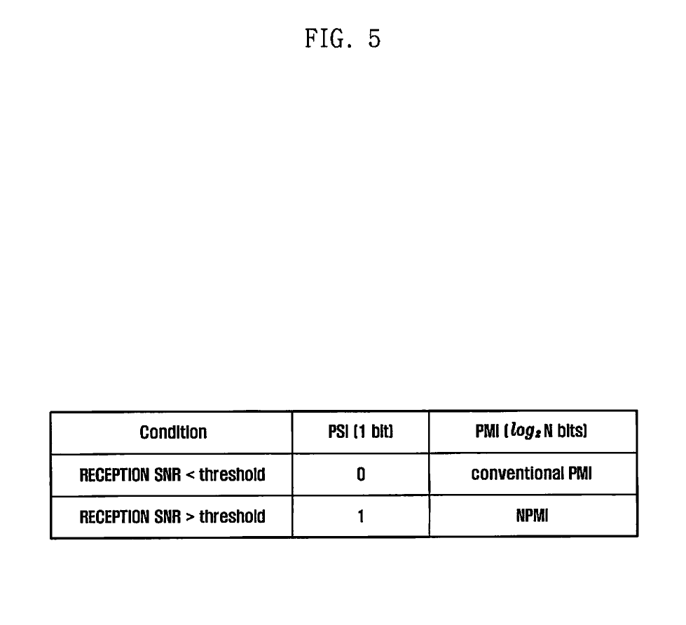

Referring to FIG. 4, according to an embodiment, a 1 bit feedback may be added in order to determine whether the fed-back PMI is the conventional PMI or the NPMI. In the related art, due to a high quantization error, a large gain cannot be obtained by adding the 1 bit feedback. However, according to the present invention, when the NPMI is fed back in a high reception SNR area, a certain gain can be obtained. This 1 bit is a barometer which notifies of whether a pre-coder is switched, and thus, may be called a Precoder Switching Indicator (PSI). For example, as illustrated in FIG. 5, when the reception SNR is lower than a threshold value, the PSI is configured to be 0 and transmitted in order to indicate that the PMI is fed back. Meanwhile, when the reception SNR is larger than the threshold value, the NPMI is fed back, so that the PSI is configured to be 1 and transmitted in order to notify that the pre-coder is switched.

According to an embodiment, it may be configured that the UE performs a feedback of the PMI or the NPMI according to a cell region.

FIG. 5 is a view illustrating a PMI/NPMI feedback area according to an embodiment of the present invention.

Referring to FIG. 5, the PMI feedback region and the NPMI feedback region may be configured in advance. A region within a predetermined distance from a BS 410 may be configured to be an NPMI feedback region, and a region deviating from the predetermined distance may be configured to be a PMI feedback region 440. UEs 421 and 423 within the NPMI feedback region 430 may be configured to feed the NPMI to the BS, and a UE 425 within the PMI feedback region 440 may be configured to feed the PMI to the BS. The BS 410 can notify the UE of whether the UE exists within the NPMI feedback region 430. A range of the NPMI feedback region 430 may be configured to be an average value in advance or may be changed according to the size of the reception SNR.

When there are two UEs, a UE k may be estimated by Equation (5).

$${SINR}_{MU , k} = \frac{1}{{\vert {h}_{k}^{H} {w}_{nk} \vert}^{2} + 2 / ρ} \qquad ( 5 )$$

When there are two UEs, and the PMI and the NPMI are complexly fed back, the following scheduling method may be used.

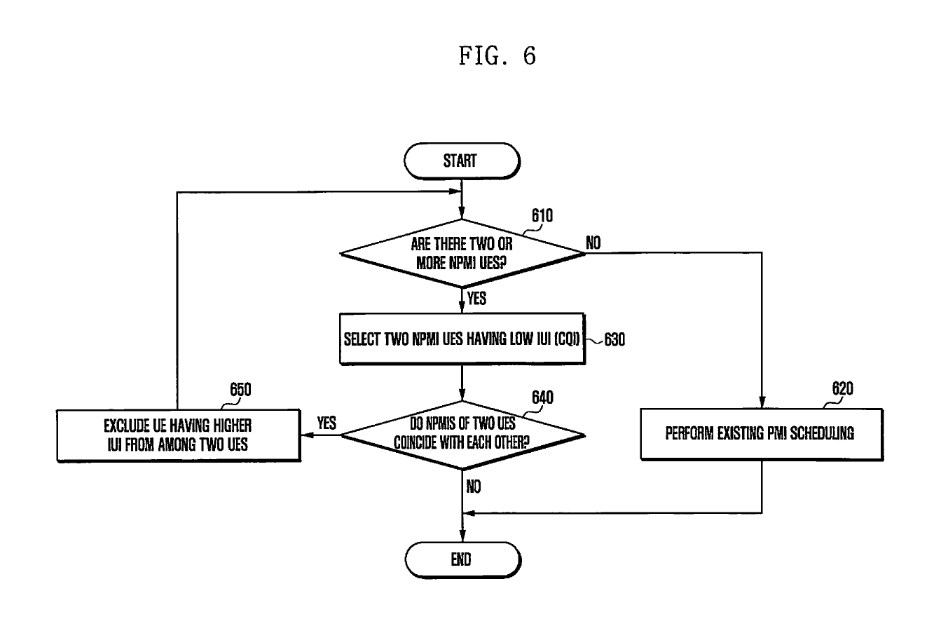

FIG. 6 is a flowchart illustrating a method of selecting two NPMI UEs according to an embodiment of the present invention.

The selection of the two NPMI UEs corresponds to a method of selecting and supporting two NPMI UEs because the NPMI UE has a better reception SNR than the PMI UE due to the pre-coder switching criterion described in Equation (4).

In step 610, it is determined that there are two or more NPMI UEs. At this time, when there are two or fewer supportable NPMI UEs, the conventional scheduling is applied only to the PMI UE, in step 620.

When there are two or more supportable NPMI UEs, two NPMI UEs having the lowest IUI (CQI) are selected. Since the selected two UEs should not perform nulling of signals thereof, it is determined in step 640 whether the NPMIs of the selected two UEs coincide with each other.

When it has been determined in step 640 that the NPMIs of the two selected UEs coincide with each other, a UE having a higher IUI from among the two UEs is excluded, and steps 610 to 640 are repeated. When it has been determined in step 640 that the NPMIs of the two selected UEs are different from each other, the selected two UEs are scheduled.

Hereinabove, the PMI/NPMI feedback according to the size of the reception SNR has been described.

Hereinafter, a PMI/NPMI feedback according to a feedback time will be described.

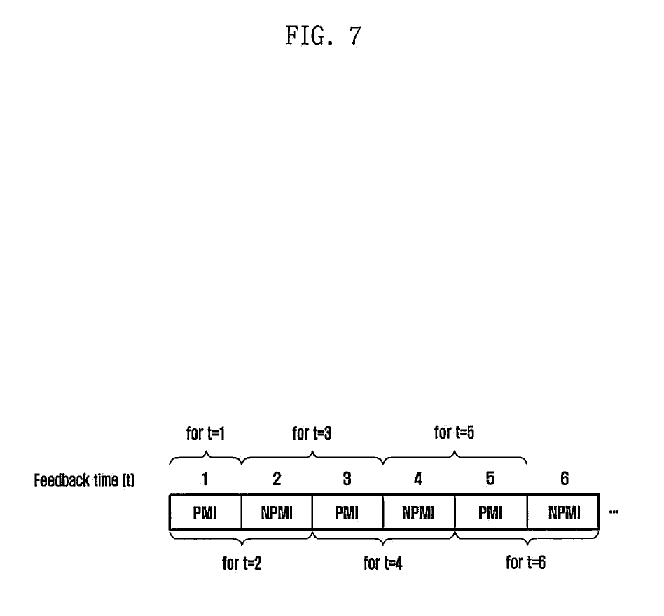

FIG. 7 is a view illustrating a switching process between PMI/NPMI according to an embodiment of the present invention.

According to an embodiment, in a time correlated channel, a UE can be supported using both a PMI and an NPMI even without a separate 1 bit PSI indicating whether the PMI is transmitted or the NPMI is transmitted.

Referring to FIG. 7, when the PMI or the NPMI is fed back at every feedback time, information of the PMI/NPMI at a previous feedback time with reference to one feedback time can be additionally used in addition to the PMI/NPMI at the one feedback time. A PMI-to-NPMI ratio may be expressed as R_{T} which is a ratio of the number of times of feedbacks of NPMIs to the number of times of feedbacks of PMIs. For example, R_{T}=1 implies that the

PMI and NPMI are toggled and fed back at every time, and R_{T}=2 implies that the PMI is fed back two times and the NPMI is then fed back one time. As illustrated in FIG. 7, when R_{T}=1, the UE repeatedly performs feedback of the PMI at a feedback time t of 1, performs feedback of the NPMI at the feedback time t of 2, and performs feedback of the PMI at the feedback time t of 3 again. Such a feedback ratio PNR of the PMI/NPMI may be stored in the UE in an average value in advance. Otherwise, according to an embodiment, when a coherence time is changed, a BS can notify the UE of the change, and then change a value thereof. This value can be transmitted in a communication scheme such as an RRC, a PDCCH, etc.

In this case, it is possible to perform developed precoding which reduces the IUI while enhancing a signal of the UE. For example, when the PMI is fed back at a current feedback time, it is possible to enhance a signal of the UE using a PMI currently fed back and reduce an inter-UE interference using an NPMI fed back at a previous feedback time. In addition, since two types of CQIs are used, it is possible to minimize a miss-match between an estimated SINR and an actual SINR. Scheduling will be exemplified below.

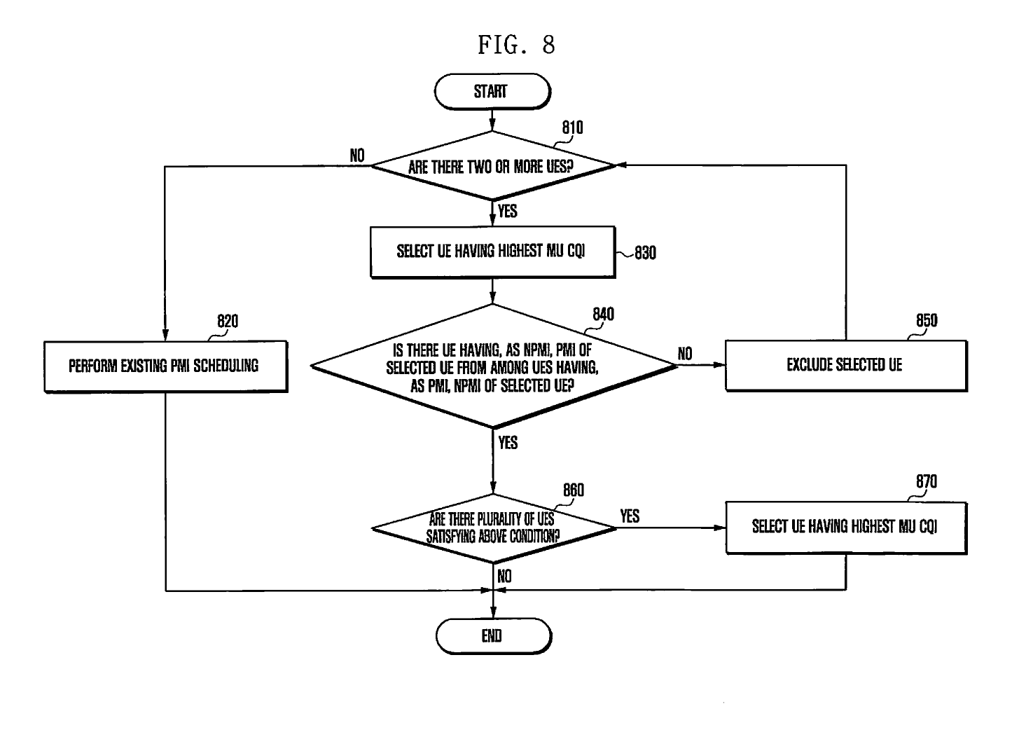

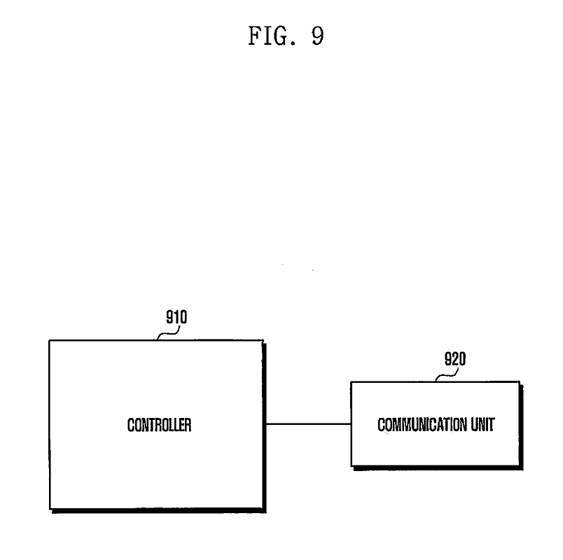

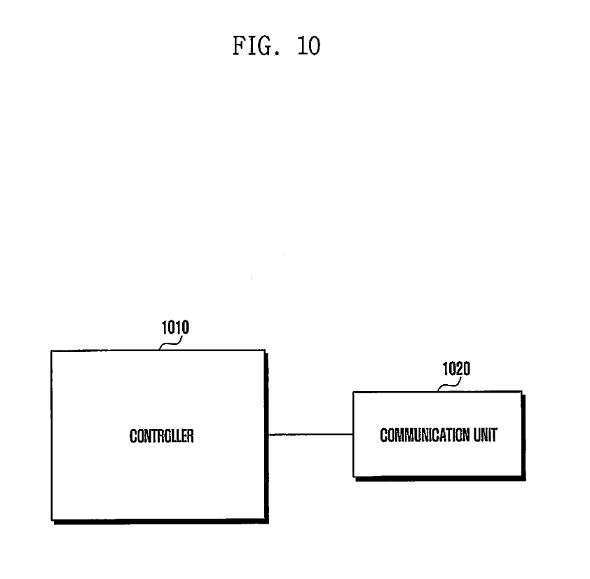

FIG. 8 is a flowchart illustrating a method of selecting a partner UE according to an embodiment of the present invention.

Referring to FIG. 8, in step 810, it is determined whether there are two or more UEs. At this time, when there are two or fewer supportable UEs, the scheduling is applied using only a PMI, in step 820.

When there are two or more UEs, a BS selects a UE having the highest SINR, in step 830. At this time, the BS can estimate an SINR according to Equation (6), and can select a UE having the highest SINR as a first UE according to a result of the estimation.

$${SINR}_{MU , k} = \frac{{\vert {h}_{k}^{H} {w}_{pk} \vert}^{2}}{{\vert {h}_{k}^{H} {w}_{nk} \vert}^{2} + 2 / ρ} \qquad ( 6 )$$

When the UE selected in step 830 is the first UE, it is determined in step 840 whether there is a UE having, as an NPMI, a PMI of the selected first UE from among UEs having, as a PMI, an NPMI of the selected first UE.

When it is determined in step 840 that there is a UE having, as an NPMI, the PMI of the selected first UE from among the UEs having, as a PMI, the NPMI of the selected first UE, the number of UEs satisfying the condition is determined, in step 860.

When it is determined in step 860 that there is only one UE satisfying the condition, the UE having, as an NPMI, the PMI of the selected first UE from among the UEs having, as a PMI, the NPMI of the selected first UE is selected as a partner UE.

Further, when it is determined in step 860 that there are two or more UEs satisfying the condition, a UE having the highest SINR from among the UEs having, as an NPMI, the PMI of the selected first UE from among the UEs having, as a PMI, the NPMI of the selected first UE is selected as a partner UE.

When it is determined in step 840 that there is no UE having, as an NPMI, the PMI of the selected first UE from among the UEs having, as a PMI, the NPMI of the selected first UE, the first UE selected in step 830 can be excluded, in step 850. Thereafter, the BS can select a second UE having the second highest SINR next to the first UE in steps 810 to 830. Thereafter, a partner UE of the second UE can be selected by performing steps 840 to 870.

Further, since there is no UE having, as an NPMI, the PMI of the UE selected in step 830 from among the UEs having, as a PMI, the NPMI of the UE selected in step 830, the selection of the UE selected in step 830 is excluded in step 850. Thereafter, when only one UE remains, the scheduling may be performed using only a reference PMI, in step 820.

FIG. 9 is a block diagram illustrating a UE according to an embodiment of the present invention.

Referring to FIG. 9, a controller 910 controls the UE to perform any one operation of the above-described embodiments. For example, the controller 910 can make a control to estimate a channel of the UE itself, calculate a first precoding matrix indication having a minimum correlation with the estimated channel, and transmit the calculated first precoding matrix indication to the BS. Further, according to an embodiment, the controller can make a control to calculate an SNR of the UE, determine whether the calculated SNR is larger than a predetermined threshold value, and when the calculated SNR is larger than the predetermined threshold value, transmit the calculated first precoding matrix indication to the BS.

Further, a communication unit 920 transmits/receives a signal according to any one operation of the above-described embodiments. For example, the communication unit 920 can transmit the calculated first precoding matrix indication to the BS.

FIG. 10 is a block diagram illustrating a BS according to an embodiment of the present invention.

Referring to FIG. 10, a controller 1010 controls the BS to perform one of the operations described in the aforementioned embodiments. For example, the controller 1010 can make a control to receive, from the first UE, the first precoding matrix indication having the minimum correlation with the channel of the first UE itself, and determine a precoding matrix indication for communication of the second UE using the first precoding matrix indication. Further, according to an embodiment, the controller 1010 can make a control to receive, from the first UE, an indicator indicating whether the precoding matrix indication received from the first UE is the first precoding matrix indication having the minimum correlation with the channel of the first UE, and determine whether the precoding matrix indication received through the indicator is the first precoding matrix indication. Further, the controller 1010 can make a control to allow the BS to perform an operation according to the flowcharts of FIGS. 6 and 8 and the descriptions relating thereto.

Further, a communication unit 1020 transmits/receives a signal according to any one operation of the above-described embodiments. For example, the communication unit 1020 can receive, from the UE, the first precoding matrix indication.

Embodiments of the present invention disclosed in the specification and the drawings are only particular examples to easily describe the technical matters of the present invention and assist for understanding of the present invention, but do not limit the scope of the present invention. It is apparent to those skilled in the art that other modified examples based on the technical idea of the present invention can be implemented as well as the embodiments disclosed herein.

Therefore, the detailed descriptions should not be construed to be limited in all aspects, but should be considered to be an example. The scope of the present invention should be determined by rational interpretation of the appended claims, and all modifications within a range equivalent to the present invention should be construed as being included in the scope of the present invention.

1. A communication method of a UE in a Multi-Input Multi-Output (MIMO) system, the communication method comprising:
estimating a channel;
calculating a first precoding matrix indication having a minimum correlation with the estimated channel; and
transmitting the calculated first precoding matrix indication to a Base Station (BS).

2. The communication method of claim 1, wherein the transmitting of the calculated first precoding matrix indication to the BS comprises:
calculating a Signal-to-Noise Ratio (SNR) of the UE;
determining whether the calculated SNR is larger than a predetemined threshold value; and
when the calculated SNR is larger than the predetermined threshold value, transmitting the calculated first precoding matrix indication to the BS.

3. The communication method of claim 2, further comprising:
calculating a second precoding matrix indication having a maximum correlation with the estimated channel; and
when the calculated SNR is smaller than the predetermined threshold value, transmitting the second precoding matrix indication having the maximum correlation of the channel of the UE itself to the BS.

4. The communication method of claim 2, further comprising:
receiving the predetermiend threshold value from the UE.

5. The communication method of claim 1, wherein the transmtiting the calculated first precoding matrix indication to the BS comprises:
performing the transmitting while including an indicator indicating whether the first precoding matrix indication is transmitted.

6. The communication method of claim 1, wherein the transmitting of the calculated first precoding matrix indication to the BS comprsies:
calculating a second precoding matrix indication having a maximum correlation with the estimated channel;
transmitting the first precoding matrix indication to the BS in a predetermined first period; and
transmitting the second precoding matrix indication in a predetermined second period.

7. The communication method of claim 6, further comprising:
receiving the predetermined first transmission period and the predetermiend second transmission period from the BS.

8. A communication method of a BS in a MIMO system, the communication method comprising:
receiving, from a first UE, a first precoding matrix indication having a minimum correlation with a channel of the first UE itself; and
determining a precoding matrix indication to be used for communication of a second terminal using the first precoding matrix indication.

9. The communication method of claim 8, wherein the receiving of the first precoding matrix indication comprises:
receiving an indicator indicating whether a precoding matrix indication received from the first UE is the first precoding matrix indication having the minimum correlation with the channel of the first UE; and
determining whether the precoding matrix indication received through the indicator is the first precoding matrix indication.

10. A UE of a MIMO system, the UE comprising:
a communication unit that communicates with a BS; and
a controller that makes a control to estimate a channel, calculate a first precoding matrix indication having a minimum correlation with the estimated channel, and transmit the calculated first precoding matrix indication to the BS.

11. The UE of claim 10, wherein the controller makes a control to calculate an SNR of the UE, determine whether the calculated SNR is larger than a predetermined threshold value, and when the calculated SNR is larger then the predetermined threshold value, transmit the calculated first precoding matrix indication to the BS.

12. The UE of claim 11, wherein the controller makes a control to calculate a second precoding matrix indication having a maximum correlation with the estimated channel, and, when the calculated SNR is smaller than the predeterrmined threshold value, transmit, to the UE, the second precoding matrix indication having the maximum correlation with the channel of the UE itseft.

13. The UE of claim 11, wherein the communication unit receives the predetermined threshold value from the BS.

14. The UE of claim 10, wherein the controller makes a control to perform the transmitting while including an indicator indicating whether the first precoding matrix indication is transmitted.

15. The UE of claim 10, wherein the controller makes a control to calculate a second precoding matrix indication having a maximum correlation with the estimated channel, transmit the first precoding matrix indication to the BS in a predetermined first period, and transmit the second precoding matrix indication in a predetermined second period.

16. The UE of claim 15, wherein the communication unit receives the predetermined first transmission period and the predetermined second transmission period to the BS.

17. A BS in a MIMO system, the BS comprising:
a communication unit that communicates with a UE; and
a controller that makes a control to receive, from a first UE, a first precoding matrix indication having a minimum correlation with a channel of the first UE itself, and determine a precoding matrix indication to be used for communication of a second UE, using the first precoding matrix indication.

18. The BS of claim 17, wherein the controller makes a control to receive, from the first UE, an indicator indicating whether the precoding matrix indication received from the first UE is the first precoding matrix indication having the minimum correlation with the channel of the first UE, and determine whether the precoding matrix indication received through the
indicator is the first precoding matrix indication.
